(19) United States
(12) Patent Application Publication
(10) Pub. No.: US 2020/0330934 A1
(43) Pub. Date: Oct. 22, 2020

(54) CONFINED PLUNGING LIQUID JET REACTOR WITH MODIFIED DOWNCOMER

(71) Applicant: KUWAIT UNIVERSITY, SAFAT (KW)

(72) Inventor: BADER SHAFAQA AL-ANZI, ABDULLAH AL MUBARAK (KW)

(21) Appl. No.: 16/386,219

(22) Filed: Apr. 16, 2019

(51) Int. Cl. B01F 5/02; B01F 3/04

(52) U.S. Cl. CPC B01F 5/0212; B01F 3/04496; B01F 3/04439

(57) ABSTRACT

The confined plunging liquid jet reactor with modified downcomer includes a downcomer having an upper end, an open lower end, and a gas inlet for receiving gas. A plurality of longitudinally-extending baffles and/or a sieve are mounted in the downcomer, adjacent the open lower end thereof. A nozzle is mounted on the upper end of the downcomer for receiving a pressurized liquid from an external source to generate a liquid jet. The liquid jet impinges on liquid contained within the downcomer creating turbulence and bubbles with the gas entrained therein. The open lower end of the downcomer is positioned within a receiving tank holding a reservoir of the liquid such that a portion of the mixture of the liquid and the gas exits the open lower end of the downcomer to flow into the receiving tank.

### BACKGROUND

### 1. Field

The disclosure of the present patent application relates to gas-liquid reactors, and particularly to a confined plunging liquid jet reactor with a modified downcomer designed to reduce bubble disentrainment.

### 2. Description of the Related Art

There are many industrial processes where it is necessary to mix a gas, such as air, with a liquid. Although sometimes a simple sparged system with a tube or air stone releasing bubbles directly below the surface of the water will suffice, for some processes, e.g., aerobic wastewater treatment, air pollution abatement, froth flotation and fermentation, an improved gas absorption rate is desirable. In such circumstances, a plunging jet reactor may be used to achieve a high mass transfer rate at low capital and operating cost.

Plunging jet devices improve gas absorption rates by creating a fine dispersion of bubbles and by increasing the contact time between the gas bubbles and the liquid at relatively low power inputs. A plunging jet may be operated as an unconfined device or as a confined device. In an unconfined plunging jet reactor system, a liquid jet plunges into an open liquid pool, creating a conical downflow dispersion of fine bubbles and a surrounding upflow of larger, coalesced bubbles. The penetration depth of the bubbles is small due to the spreading of the submerged jet, and hence the bubble contact time with the liquid is short.

In a confined system, a Confined Plunging Liquid Jet Reactor (CPLJR) uses a vertical tube or downcomer column that surrounds the liquid jet and that is partially immersed in the receiving liquid pool contained in a reservoir. Hence, the entrained bubbles may be carried to large depths by the liquid downflow. The top end of the tube is connected to a nozzle, while the other end (bottom) is left open to the receiving liquid pool.

FIG. 2 illustrates a conventional confined plunging liquid jet reactor (CPLJR) 100. Pressurized liquid L passes through a nozzle 102, which is vertically oriented and creates a high velocity jet of liquid 104 that impinges into a body of fluid 106 located beneath the nozzle 102. Gas G may either be injected into the liquid upstream of the nozzle 102 or, as shown in FIG. 2, may be drawn into the process near the point of impingement. The plunging jet 104 impinges into the body of fluid 106, which is confined by downcomer 108. Near the point of impingement is a highly energetic, turbulent zone where the downward force of the plunging jet 104 fights buoyancy forces of the entrained gas G. This zone, called the “mixing zone” 110, is characterized by vigorous mixing of the gas and liquid, with a high gas-to-liquid surface area due to the small gas bubble size created by the impinging jet 104. The bulk of the high-efficiency gas/liquid contacting occurs in mixing zone 110. Below the mixing zone 110 is a zone called the “pipe flow zone” 112. The pipe flow zone 112 is characterized by a less turbulent flow pattern, where the liquid and excess gas both flow downward to exit the downcomer 108 at its open lower end 114 into a receiving tank 116.

Improvements in the gas mass rate transfer into liquid can be achieved by increasing the liquid jet penetration depth and the contact time between the gas and liquid, as well as increasing the gas-liquid contact surface through hindering or reducing descending primary bubble coalescence into secondary ascending bubbles. With regard to the latter, smaller bubbles tend to give better mass transfer rates. However, despite the various parameters that may be varied in order to improve the mass transfer rate, conventional CPLJ reactors, such as reactor 100, still suffer the drawback of gas rising from the receiving tank 116 back into the open lower end 114 of the downcomer 108. This factor is referred to as the “disentrainment rate”, and depends upon the process operating conditions, such as the jet velocity, nozzle diameter, downcomer diameter, and jet length. It would obviously be desirable to be able to minimize or remove disentrainment of the bubbles from the CPLJR process, resulting in improvement of gas entrainment into the liquid, as well as reducing the size of the gas bubbles to improve mass transfer. Thus, a confined plunging liquid jet reactor with a modified downcomer solving the aforementioned problems is desired.

### SUMMARY

The confined plunging liquid jet reactor with a modified downcomer includes a downcomer having an upper end, an open lower end, and a gas inlet for receiving gas from an external source. A plurality of longitudinally-extending baffles are mounted on an inner surface of the downcomer adjacent the open lower end thereof. A nozzle is mounted on the upper end of the downcomer for receiving a pressurized liquid from an external source to generate a liquid jet. The liquid jet impinges on a mixture of the liquid and the gas contained within the downcomer. The open lower end of the downcomer is positioned within a receiving tank such that a portion of the mixture of the liquid and the gas exits the open lower end of the downcomer to flow into the receiving tank. In use, the longitudinally-extending baffles interfere with toroidal and swirling fluid motions that occur inside the downcomer. This reduces the disentrainment of gas bubbles, thus increasing the net entrainment rate.

In an alternative embodiment, the longitudinally-extending baffles may be removed from the downcomer and replaced by a sieve or porous screen, which is mounted transversely within the downcomer. The porous screen hinders bubble coalescence by breaking the air bubbles into smaller/primary bubbles, increasing the bubble penetration depth, and thus increasing mass transfer. In another embodiment, the downcomer column may be modified to include both longitudinal baffles and at least one sieve.

These and other features of the present disclosure will become readily apparent upon further review of the following specification.

### BRIEF DESCRIPTION OF THE DRAWINGS

FIG. 1 is a schematic diagram of a confined plunging liquid jet reactor with a modified downcomer having longitudinal baffles.

FIG. 2 is a schematic diagram of a conventional prior art confined plunging liquid jet reactor.

FIG. 3 is a diagrammatic top view of the modified downcomer of the confined plunging liquid jet reactor of FIG. 1.

FIG. 4 is a schematic diagram of an alternative embodiment of the confined plunging liquid jet reactor with modified downcomer having a sieve.

FIG. 5 is a perspective view of the modified downcomer of the confined plunging liquid jet reactor of FIG. 4.

FIG. 6 is a plot comparing air entrainment rates for the confined plunging liquid jet reactor with modified downcomer of FIG. 4 with varying pore diameters of the sieve.

Similar reference characters denote corresponding features consistently throughout the attached drawings.

### DETAILED DESCRIPTION OF THE PREFERRED EMBODIMENTS

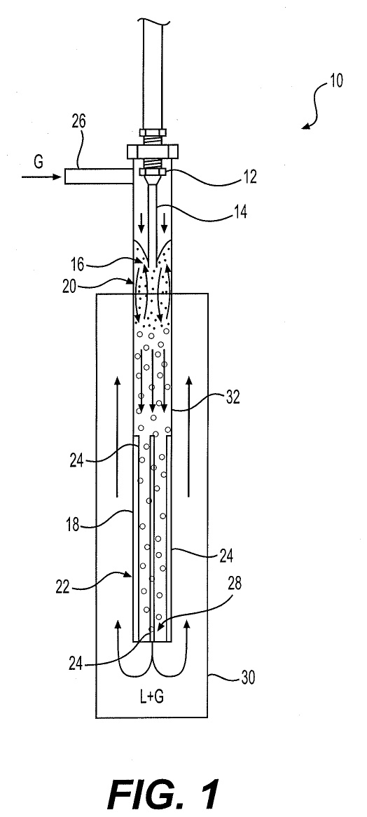

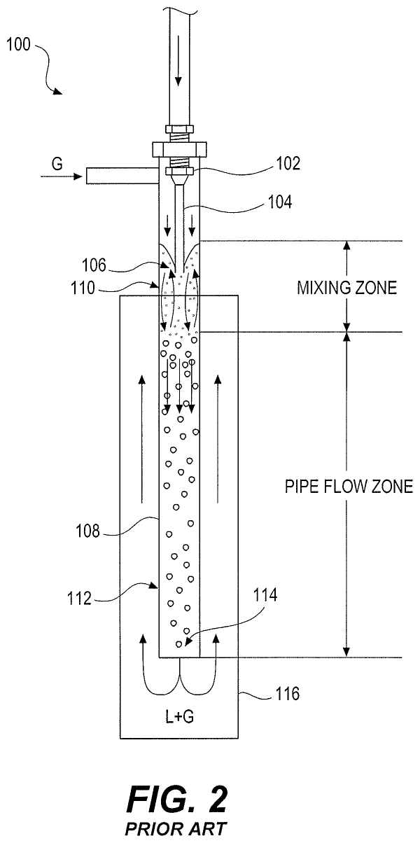

As shown in FIG. 1, the confined plunging liquid jet reactor (CPLJR) with modified downcomer 10 is similar to the conventional CPLJR 100 of FIG. 2, but with additional baffles 24 mounted within the downcomer 18. Similar to CPLJR 100, the confined plunging liquid jet reactor with modified downcomer 10 includes a nozzle 12 for receiving pressurized liquid L. Nozzle 12 is mounted on the closed upper end of downcomer 18. However, it should be understood that the nozzle 12 is shown in FIG. 1 for exemplary purposes only, and that any suitable type of nozzle, and any suitable arrangement or orientation of nozzle 12, may be used.

The nozzle 12 is vertically oriented and creates a high velocity jet of liquid 14 that impinges into a body of liquid 16 located beneath the nozzle 12. Gas G is drawn into the process near the point of impingement through gas inlet 26, or the gas may be air from the headspace in the downcomer above the liquid 16. The plunging jet 14 impinges into the body of liquid 16, which is confined by the downcomer 18. The downward force of the plunging jet 14 fights buoyancy forces of the entrained gas G within a mixing zone 20. The gas-liquid mixture (G+L) flows down through a pipe flow zone 22, such that the liquid and excess gas both flow downward to exit the downcomer 18 at its open lower end 28 into a receiving tank 30. Although not clearly shown in the schematic diagrams of FIGS. 1 and 2, it will be understood that the receiving tank 30 holds a liquid reservoir, which is the source of the liquid 16 in the downcomer 18 that the jet 14 of pressurized liquid impacts, the CPLJR 10 being used to mix the gas into solution in the liquid reservoir.

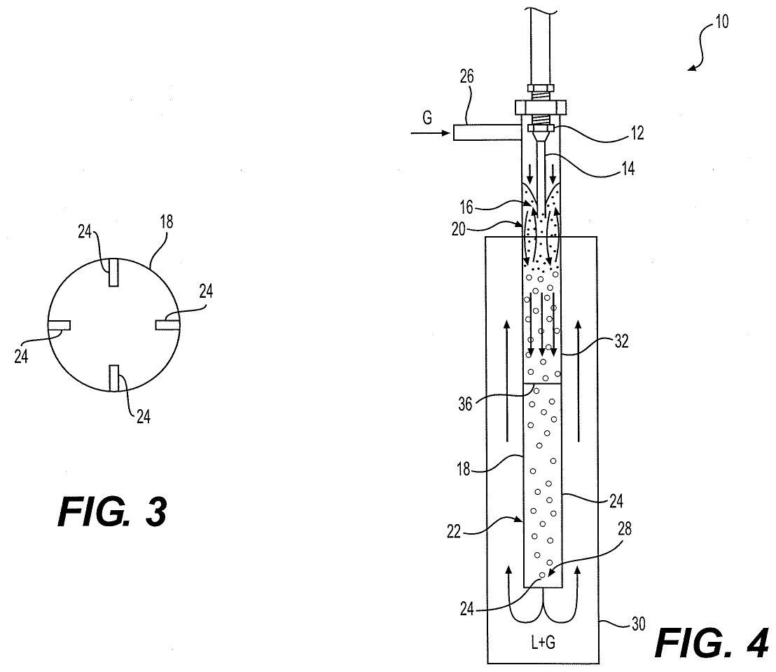

As noted above, and as shown in FIGS. 1 and 3, a plurality of vertically or longitudinally-extending baffles 24 are mounted on an inner surface 32 of downcomer 18 adjacent the open lower end 28, the baffles extending radially inward into the column defined by the downcomer 18. The bubbles are able to achieve deeper depths due to hindrance of the primary bubbles coalescing to form secondary bubbles (which have a higher rise/slip velocity). The longitudinally-extending baffles 24 interfere with the toroidal and swirling fluid motions that occur inside downcomer 18. This reduces the disentrainment of the bubbles, thus increasing the net entrainment rate. It should be understood that the baffles 24 shown in FIGS. 1 and 3 are shown for exemplary purposes only, and that their number, overall configuration, positioning with respect to the downcomer 18, and their relative dimensions may be varied based upon the fluid dynamic parameters of the overall confined plunging liquid jet reactor 10.

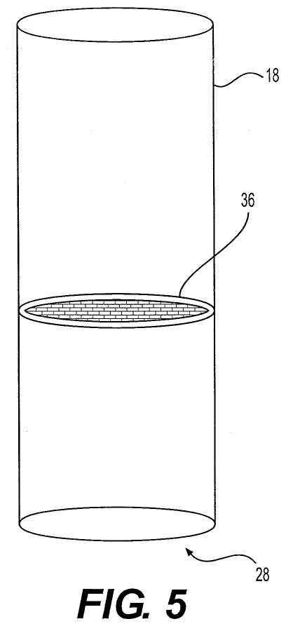

The alternative embodiment shown in FIGS. 4 and 5 is similar to the previous embodiment, but the baffles 24 have been removed from the downcomer 18 and have been replaced by a sieve or porous screen 36 mounted transversely within the downcomer 18. The horizontally extending porous screen 36 hinders bubble coalescence by breaking the air bubbles into smaller/primary bubbles, increasing the bubble penetration depth, and thus increasing the mass transfer. It should be understood that the porous screen 36 is shown in FIGS. 4 and 5 for exemplary purposes only, and that its thickness, pore density, pore shape, pore size, overall configuration, and depth with respect to the downcomer 18 may be varied based upon the fluid dynamic parameters of the overall confined plunging liquid jet reactor 10.

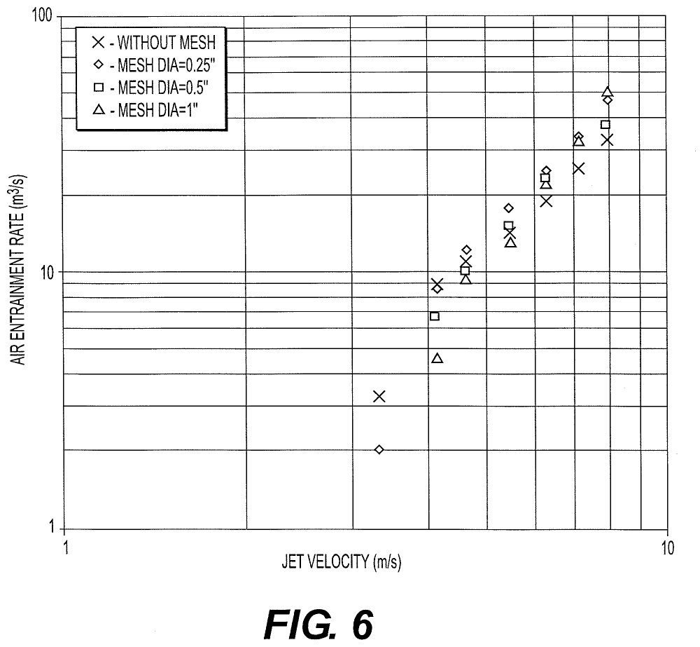

In order to test the confined plunging liquid jet reactor with modified downcomer 10 of FIGS. 4 and 5, porous screens were made from mesh having a variety of pore diameters. FIG. 6 shows the measured air entrainment rate as a function of jet velocity for a confined plunging liquid jet reactor with no mesh screen (i.e., a control reactor similar to reactor 100 of FIG. 2), and confined plunging liquid jet reactors configured similarly to that shown in FIGS. 4 and 5, with pore diameters of 0.25 inches, 0.5 inches, and 1.0 inches. It can be clearly seen that the use of the porous screen 36 generates higher net air entrainment rates when compared to the control. It can also be seen that the air entrainment rate increases with a decrease in pore diameter.

It is to be understood that the confined plunging liquid jet reactor with modified downcomer is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A confined plunging liquid jet reactor with modified downcomer, comprising:
a downcomer having an upper end, an open lower end, and a gas inlet for receiving gas from an external source, the downcomer defining a hollow column;
a plurality of longitudinally-extending baffles projecting radially inward into the hollow column defined by the downcomer adjacent the open lower end thereof;
a nozzle mounted on the upper end of the downcomer, the nozzle being adapted for receiving a pressurized liquid from an external source and configured to generate a liquid jet downward in the hollow column; and
a receiving tank adapted for holding a liquid reservoir having a surface, the open lower end of the downcomer being positioned in the liquid reservoir with the surface rising in the column to a level below the nozzle such that the jet of pressurized liquid creates turbulence and bubbles of gas in the liquid reservoir when the jet impacts the surface of the liquid reservoir to entrain the gas in the liquid reservoir, the baffles preventing coalescence of bubbles and keeping bubble size small to prevent disentrainment of gas from the liquid reservoir and increase entrainment of gas in the liquid reservoir.

2. The confined plunging liquid jet reactor according to claim 1, further comprising a sieve extending transversely across the hollow column defined by the downcomer below said nozzle and above said baffles, the sieve further preventing coalescence of bubbles and keeping bubble size small to prevent disentrainment of gas from the liquid reservoir and increase entrainment of gas in the liquid reservoir.

3. A confined plunging liquid jet reactor with modified downcomer, comprising:
a downcomer having an upper end, an open lower end, and a gas inlet for receiving gas from an external source, the downcomer defining a hollow column;
a porous screen extending transversely across the hollow column defined by the downcomer;
a nozzle mounted on the upper end of the downcomer, the nozzle being adapted for receiving a pressurized liquid from an external source and configured to generate a liquid jet downward in the hollow column, the porous screen being below the nozzle; and
a receiving tank adapted for holding a liquid reservoir having a surface, the open lower end of the downcomer being positioned in the liquid reservoir with the surface rising in the column to a level below the nozzle such that the jet of pressurized liquid creates turbulence and bubbles of gas in the liquid reservoir when the jet impacts the surface of the liquid reservoir to entrain the gas in the liquid reservoir, the porous screen preventing coalescence of bubbles and keeping bubble size small to prevent disentrainment of gas from the liquid reservoir and increase entrainment of gas in the liquid reservoir.

4. The confined plunging liquid jet reactor as recited in claim 3, wherein the porous screen has pores with diameters between 0.25 inches and 1.0 inches.

5. A confined plunging liquid jet reactor with modified downcomer, comprising:
a downcomer having an upper end, an open lower end, and a gas inlet for receiving gas from an external source, the downcomer defining a hollow column;
a nozzle mounted on the upper end of the downcomer, the nozzle being adapted for receiving a pressurized liquid from an external source and configured to generate a liquid jet downward in the hollow column;
a receiving tank adapted for holding a liquid reservoir having a surface, the open lower end of the downcomer being positioned in the liquid reservoir with the surface rising in the column to a level below the nozzle such that the jet of pressurized liquid creates turbulence and bubbles of gas in the liquid reservoir when the jet impacts the surface of the liquid reservoir to entrain the gas in the liquid reservoir; and
means disposed in the lower end of the hollow column defined by the downcomer for preventing coalescence of bubbles and keeping bubble size small to prevent disentrainment of gas from the liquid reservoir and increase entrainment of gas in the liquid reservoir.

6. The confined plunging liquid jet reactor according to claim 5, wherein said means for preventing coalescence of bubbles and keeping bubble size small comprises longitudinally extending baffles mounted in the lower end of said downcomer, the baffles projecting radially inward into the hollow column defined by the downcomer adjacent the open lower end thereof.

7. The confined plunging liquid jet reactor according to claim 5, wherein said means for preventing coalescence of bubbles and keeping bubble size small comprises a sieve extending transversely across the hollow column defined by the downcomer.

8. The confined plunging liquid jet reactor according to claim 7, wherein said sieve has pores with diameters between 0.25 inches and 1.0 inches.

9. The confined plunging liquid jet reactor according to claim 5, wherein said means for preventing coalescence of bubbles and keeping bubble size small comprises:
longitudinally extending baffles mounted in the lower end of said downcomer, the baffles projecting radially inward into the hollow column defined by the downcomer adjacent the open lower end thereof; and
a sieve extending transversely across the hollow column defined by the downcomer above the baffles.
